(19) United States
(12) Patent Application Publication
(10) Pub. No.: US 2018/0275618 A1
(43) Pub. Date: Sep. 27, 2018

(54) INFORMATION APPARATUS AND SENSOR ATTACHING TOOL

(71) Applicant: SEIKO EPSON CORPORATION, Tokyo (JP)

(72) Inventor: Atsushi KONDO, Azumino-shi (JP)

(73) Assignee: SEIKO EPSON CORPORATION, Tokyo (JP)

(21) Appl. No.: 15/916,737

(22) Filed: Mar. 9, 2018

(30) Foreign Application Priority Data
Mar. 22, 2017 (JP) 2017-056093

(51) Int. Cl. G04G 17/04; G04G 21/02

(52) U.S. Cl. CPC G04G 17/04; G04G 21/02

(57) ABSTRACT

A sensor attaching tool is attached to a wristwatch that includes an exterior case and a display incorporated in the exterior case and is wearable on a human body for use. The sensor attaching tool includes a base section that incorporates a sensor and is disposed on the human body side of the exterior case, a ring section that is placed on an outer circumferential portion that forms the exterior case and faces the display, and a holder that allows the base section and the ring section to be held on the side facing the side surface of the exterior case.

### CROSS-REFERENCE TO RELATED APPLICATION

This nonprovisional application claims the benefit of Japanese Patent Application No. 2017-056093 filed Mar. 22, 2017, the enter disclosure which is incorporated herein by reference.

### BACKGROUND

### 1. Technical Field

The present invention relates to an information apparatus, such as a wristwatch, and a sensor attaching tool attached to the information apparatus.

### 2. Related Art

There has been a wristwatch of related art that not only has the time display function but measures the temperature or any other quantity, for example, with a temperature sensor built in the wristwatch and displays the measured temperature on a dial (see JP-A-2013-57517).

However, the information apparatus, such as a wristwatch, is worn on an arm and therefore has a limited space where the sensor is incorporated. Therefore, in a case where the information apparatus is configured to be a multi-functional information apparatus, the size of the product increases, resulting in restriction on the exterior appearance and operability and other problems.

### SUMMARY

An advantage of some aspects of the invention is to provide a sensor attaching tool that allows expansion of the function of an information apparatus and an information apparatus including the sensor attaching tool.

A sensor attaching tool according to an aspect of the invention is a sensor attaching tool attached to an information apparatus that includes an exterior case and a display incorporated in the exterior case and is wearable on a human body, the sensor attaching tool including abase section that incorporates a sensor and is disposed on a human body side of the exterior case when the information apparatus is worn on the human body, a ring section that is placed on an outer circumferential portion that forms the exterior case and faces the display, and a holder that allows the base section and the ring section to be held on a side facing a side surface of the exterior case.

The sensor attaching tool according to the aspect described above, which is externally attached to the information apparatus, allows expansion of the function of the information apparatus with no sensor incorporated in the information apparatus itself.

In the sensor attaching tool according to the aspect described above, it is preferable that the holder includes a first holder that pivotably joins the ring section and the base section to each other and a second holder that detachably fixes the ring section to the base section with each other.

Employing the structure described above that holds the ring section and the base section allows the operation of attaching and detaching the sensor attaching tool to and from the information apparatus to be performed only at one location, whereby the attachment/detachment operation is readily performed.

In the sensor attaching tool according to the aspect described above, it is preferable that the ring section has markings indicating a value measured with the sensor.

Providing the ring section with the markings as indices that indicate a value measured with the sensor allows providing the ring section with markings for the sensor provided in the sensor attaching tool. Further, the information apparatus does not need to be provided with markings for the sensor added in the sensor attaching tool.

In the sensor attaching tool according to the aspect described above, it is preferable that the ring section includes a transparent member that covers the display of the information apparatus.

Since the ring section is provided on the side facing the display, which displays information provided by the information apparatus, the member can protect the display of the information apparatus. Further, the member, which is transparent, does not hamper the visibility of information displayed on the display. The material of the member can, for example, be a glass or plastic material.

In the sensor attaching tool according to the aspect described above, it is preferable that the base section or the ring section includes a communicator that transmits a value measured with the sensor to the information apparatus. Providing the base section or the ring section with the communicator as described above allows display operation using the display function of the information apparatus, whereby the range over which the information apparatus is used can be widened.

A sensor attaching tool according to another aspect of the invention includes a band attached to an information apparatus to allow the information apparatus to be worn on a human body and a sensor container that is attached to the band and contains a sensor. The band includes a first band, a second band, a first case connected to an end of the first band, a second case connected to an end of the second band, and a third case that connects the first case and the second case to each other, and when the information apparatus is worn on the human body, the first case, the second case, and the third case are overlaid on each other, and the sensor container is detachably contained in the overlaid portion.

Since the sensor attaching tool according to the aspect described above is so attached to the information apparatus that the sensor attaching tool holds the information apparatus, the function of the information apparatus can be expanded with no sensor attached to the information apparatus itself. Further, in a case where the sensor is defective, the sensor can be readily exchanged. Moreover, a plurality of types of sensor can be switched from one to another as appropriate for measurement of a desired measurement item.

In the sensor attaching tool according to the aspect described above, it is desirable that the sensor container includes a communicator that transmits a value measured with the sensor to the information apparatus.

Providing the sensor container with the communicator as described above allows display operation using the display function of the information apparatus, whereby the range over which the information apparatus is used can be widened.

An information system according to another aspect of the invention includes an information apparatus that includes an exterior case and a display incorporated in the exterior case and is wearable on a human body and a sensor attaching tool attached to the information apparatus, and the sensor attaching tool includes abase section that incorporates a sensor and is disposed on a human body side of the exterior case when the information apparatus is worn on the human body, a ring section that is placed on an outer circumferential portion that forms the exterior case and faces the display, and a holder that allows the base section and the ring section to be held on aside facing a side surface of the exterior case.

An information system according to another aspect of the invention includes an information apparatus, a band attached to the information apparatus to allow the information apparatus to be worn on a human body, and a sensor container that is attached to the band and contains a sensor. The band includes a first band, a second band, a first case connected to an end of the first band, a second case connected to an end of the second band, and a third case that connects the first case and the second case to each other, and when the information apparatus is worn on the human body, the first case, the second case, and the third case are overlaid on each other, and the sensor container is detachably contained in the overlaid portion.

The information system according to the aspect described above, to which a measurement function is added by the sensor attaching tool, allows expansion of the function of the information apparatus with no sensor attached to the information apparatus itself.

### BRIEF DESCRIPTION OF THE DRAWINGS

The invention will be described with reference to the accompanying drawings, wherein like numbers reference like elements.

FIG. 1 is a perspective view showing an information apparatus according to a first embodiment of the invention.

FIG. 2 is a perspective view of the information apparatus according to the embodiment viewed at an angle different from the angle at which the information apparatus is viewed in FIG. 1.

FIG. 3 is a plan view showing the information apparatus according to the embodiment.

FIG. 4 is a perspective view showing a sensor attaching tool according to the embodiment.

FIG. 5 is a perspective view showing a first stage of operation of attaching the sensor attaching tool to the information apparatus in the embodiment.

FIG. 6 is a perspective view showing a second stage of the operation of attaching the sensor attaching tool to the information apparatus in the embodiment.

FIG. 7 is a block diagram for describing a function of the information apparatus according to the embodiment.

FIG. 8 is a plan view of the information apparatus showing an example of a display form in the embodiment.

FIG. 9 is a perspective view showing a variation of the sensor attaching tool according to the embodiment of the invention.

FIG. 10 is a perspective view showing an information apparatus according to a second embodiment of the invention.

FIG. 11 is a perspective view showing a sensor attaching tool according to the embodiment in FIG. 10.

### DESCRIPTION OF EXEMPLARY EMBODIMENTS

### First Embodiment

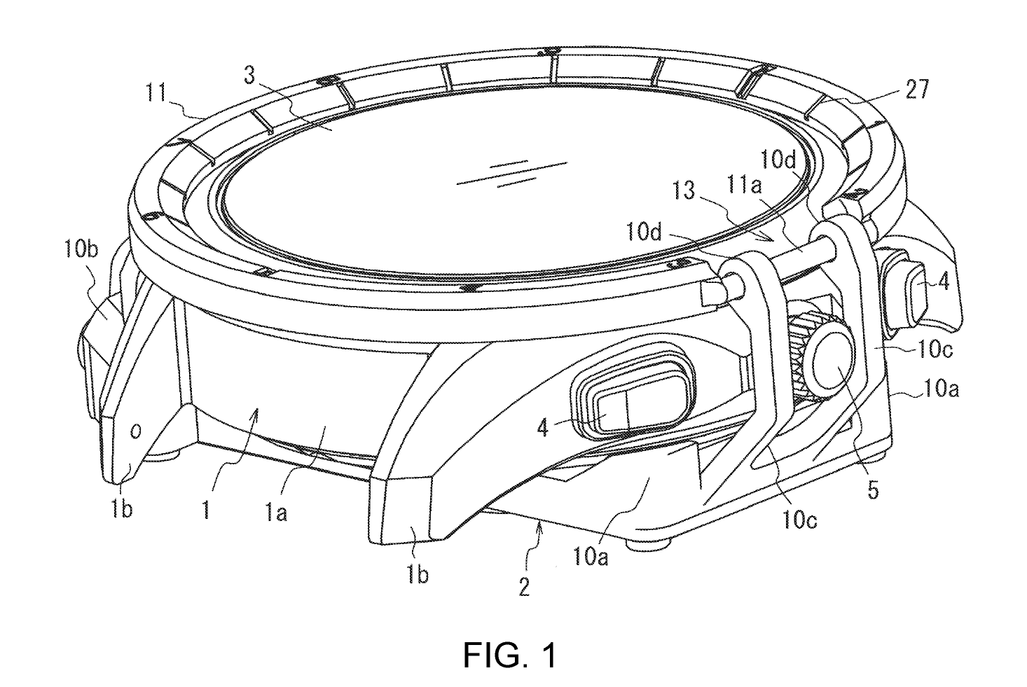

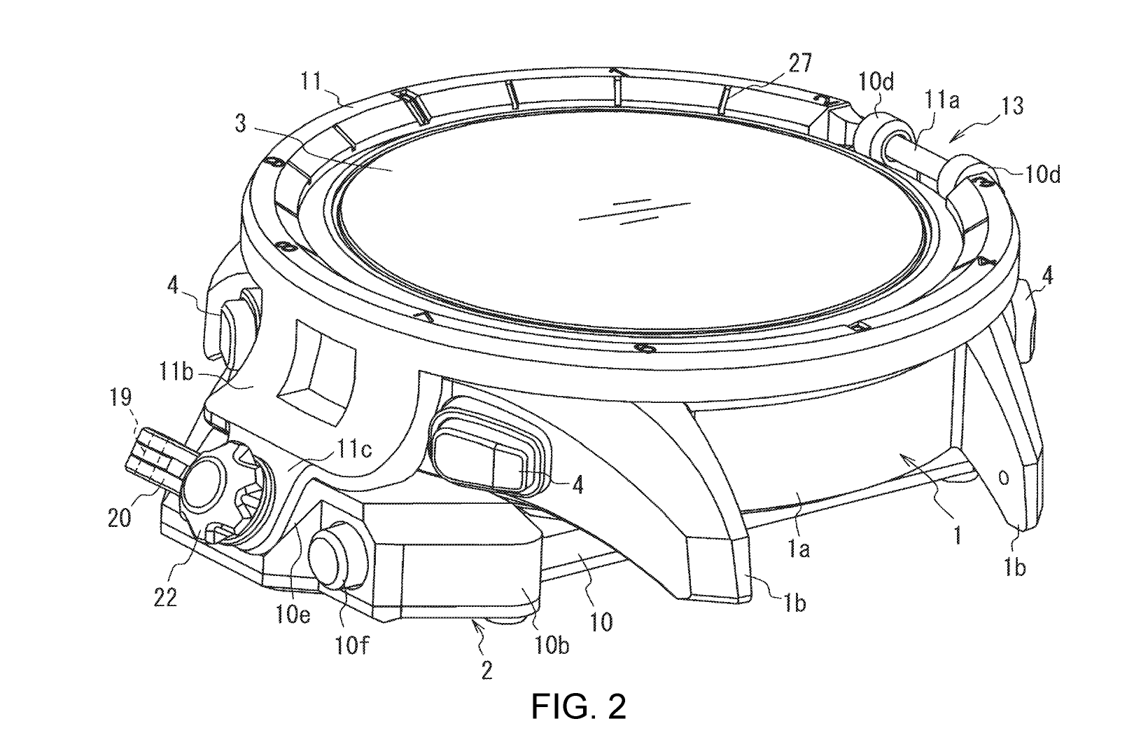

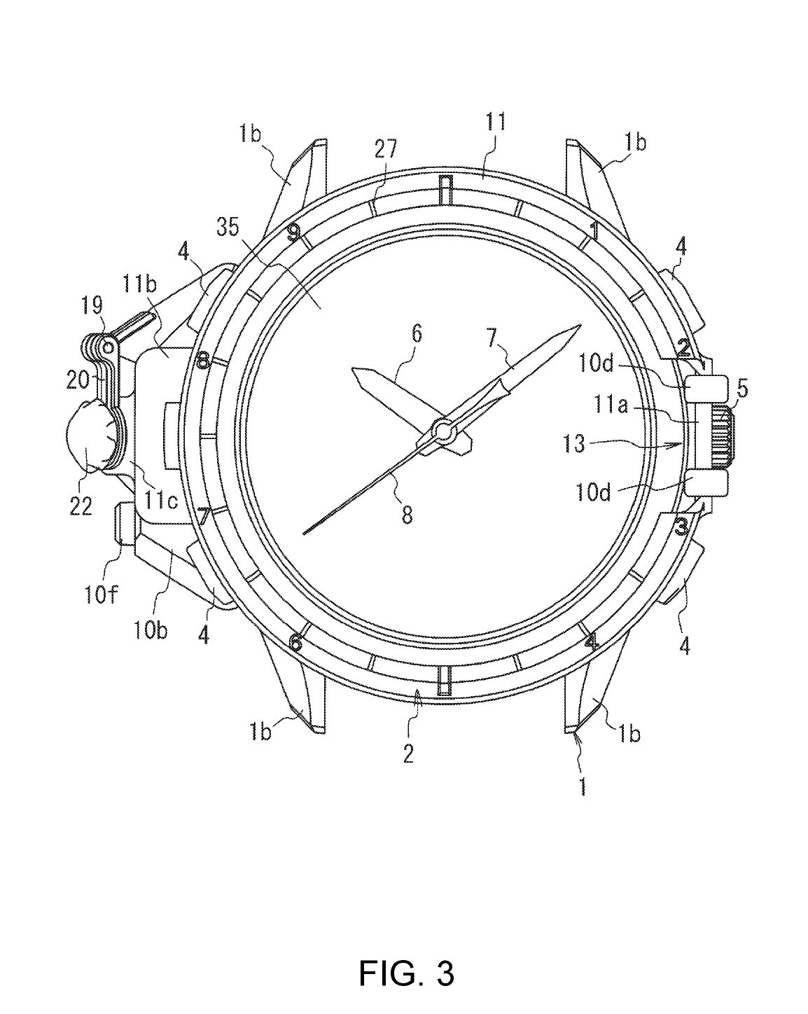

FIGS. 1 and 2 are perspective views showing an information system according to a first embodiment of the invention. The information system includes an information apparatus that can be worn on a human body for use and a sensor attaching tool 2. The thus configured information apparatus is, for example, a wrist wearable apparatus, such as an outdoor watch. In the present embodiment, a wristwatch 1 is presented as the information apparatus by way of example. FIG. 1 shows a state in which the sensor attaching tool 2 is attached to the wristwatch 1. An exterior case 1a of the wristwatch 1 includes band attachment sections 1b, to which a band (not shown) is attached, on opposite sides of the exterior case 1a and further includes a cover glass plate 3 on the upper side of the exterior case 1a. To the exterior case 1a are attached an operation knob 4 and a crown 5 for changing or otherwise modifying the display operation performed by the wristwatch 1. The wristwatch 1 further includes a display 35, which displays information, as shown in FIG. 3. Further, the present embodiment is described with reference to a case where the wristwatch 1 includes indicating hands, such as an hour hand 6, a minute hand 7, and a second hand 8, in the display section 35, but it is noted in other cases that a liquid crystal display that displays an image is further provided in addition to the indicating hands, and that only the liquid crystal display section, which displays an image, is provided but no indicating hands are provided.

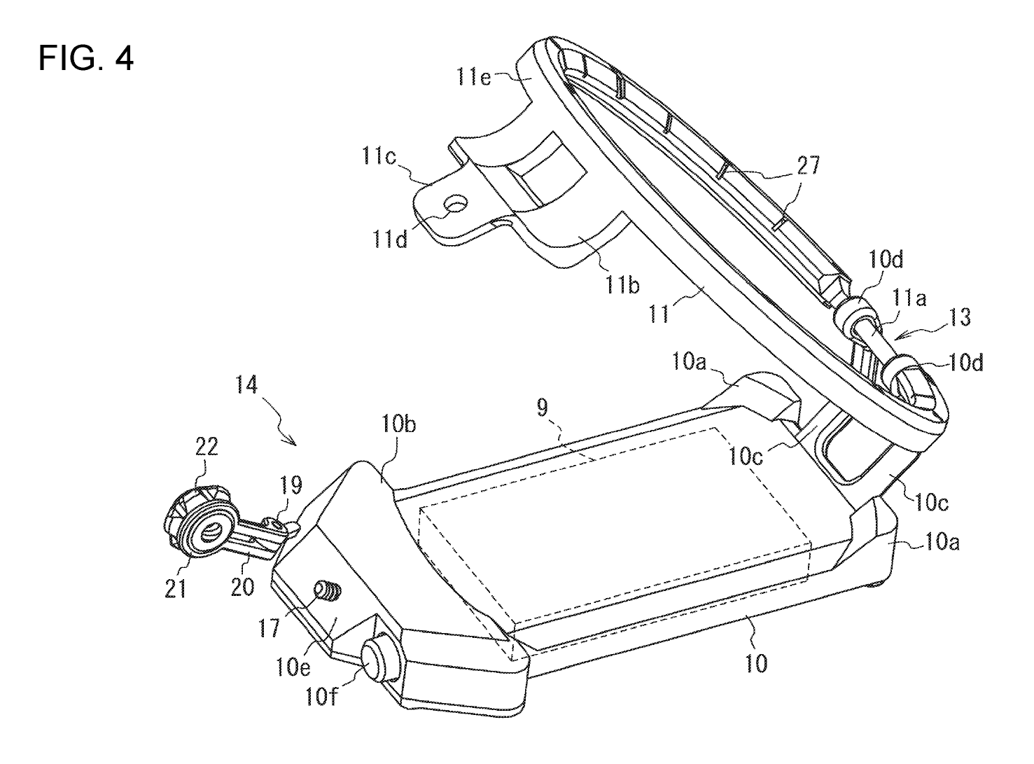

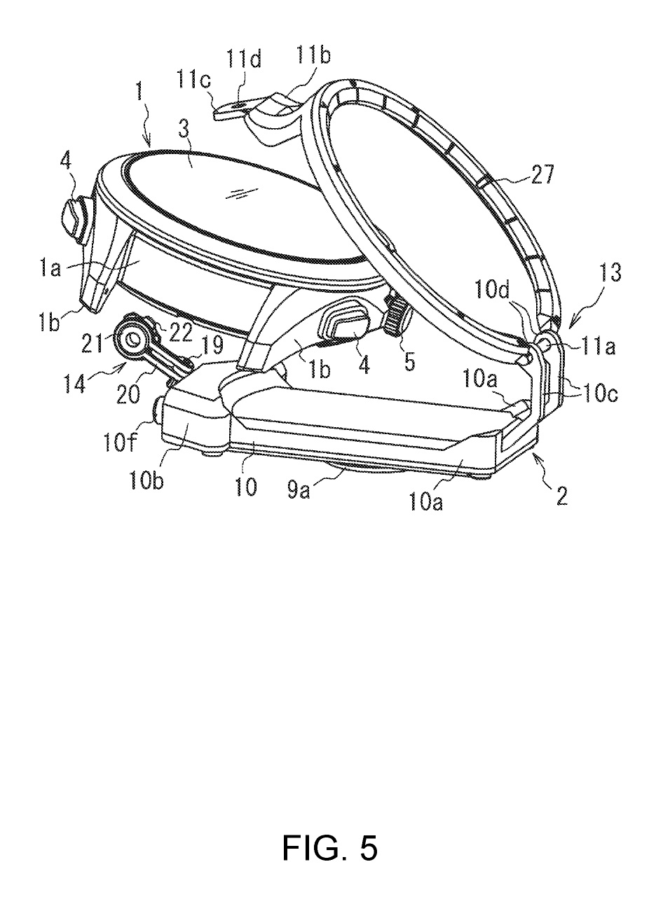

The sensor attaching tool 2 includes a base section 10, which incorporates a sensor 9, as shown in FIG. 4. In the state in which the wristwatch 1 is worn on a human body, the base section 10 is disposed on the human body side of the exterior case 1a. The sensor attaching tool 2 further includes a ring section 11, which is disposed on the side facing the display 35 of the exterior case 1a and on an outer circumference portion (bezel) of the exterior case 1a. The ring section 11 has an annular shape. The sensor attaching tool 2 further includes a holder that causes the base section 10 and the ring section 11 to be held on the side facing the side surface of the exterior case 1a of the wristwatch 1. The holder in this example is formed of a first holder 13 and a second holder 14. The first holder 13 and the second holder 14 are provided on the opposite sides of the exterior case 1a and face the side surface of the exterior case 1a. The bottom surface of the sensor 9 forms a sensing section 9a, as shown in FIG. 5.

The base section 10 is disposed on the human body side of the exterior case 1a. The base section 10 has arcuate raised sections 10a and 10b, which are provided on the upper surface of the base section 10 and into which the rear side of the wristwatch 1 is fit. The ring section 11 has an arcuate shape that exposes the circular display 35 of the wristwatch 1 when the ring section 11 is so disposed as to be in contact with the bezel on the side facing the display 35 of the wristwatch 1. In a case where the display 35 of the wristwatch 1 has a rectangular shape, the shape of the ring section 11 is so selected as to conform to the shape of the display 35. The ring section 11 has markings 27, which indicate a value measured with the sensor 9.

In the present embodiment, the first holder 13, which fixes the base section 10 and the ring section 11 to each other, has a structure that pivotably joins the ring section 11 to the base section 10. That is, the first holder 13 is formed of a pair of standing sections 10c, 10c, which are so formed as to stand from the base section 10, bearings 10d, 10d, which are provided at the top of the standing sections 10c, 10c, and a shaft 11a, which is fixed to the ring section 11 and pivotably fit into the bearings 10d, 10d.

The second holder 14, which fixes the base section 10 and the ring section 11 to each other, has a structure that detachably fixes the base section 10 and the ring section 11 to each other with a screw. That is, to form the second holder 14, the base section 10 is provided with a receiving surface 10e, which is provided on the raised section 10b of the base section 10 and receives a free end 11e (see FIG. 4) of the ring section 11, and a fastening male screw 17, which is buried through the receiving surface 10e but protrudes from the receiving surface 10e. Further, an arm 20 is so attached to a side surface of the raised section 10b as to be pivotable around a support shaft 19, and a female screw 21, which engages with the male screw 17, is so attached to the front end of the arm 20 that a knob 22 allows the female screw 21 to pivot.

To form the second holder 14, a protruding section 11b is provided at the free end 11e of the ring section 11. The protruding section 11b is so formed as to protrude downward from the ring section 11 to form a space where the wristwatch 1 is held between the ring section 11 and the base section 10 in correspondence with the thickness of the wristwatch 1. Further, to form the second holder 14, a lower end portion of the protruding section 11b is provided with a fastening piece 11c, which is so formed as to obliquely extend from the protruding section 11b, and a through hole 11d, which is formed through the fastening piece 11c. The through hole 11d is so positioned that the male screw 17 provided in the base section 10 is fit into the through hole 11d when the ring section 11 is in the closed position.

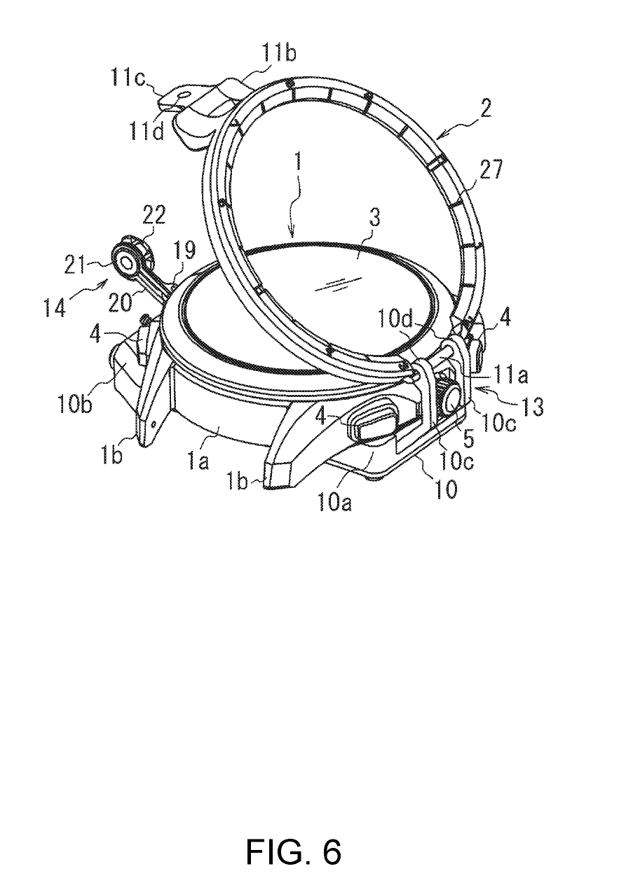

To attach the sensor attaching tool 2 according to the present embodiment to the wristwatch 1, the wristwatch 1 is inserted into the space between the base section 10 and the ring section 11, as shown in FIG. 5, and the bottom portion of the wristwatch 1 is fit into the space between the raised sections 10a and 10b on the upper surface of the base section 10, as shown in FIG. 6. At this point, the crown 5 is caused to be located between the standing section 10c, 10c of the base section 10. The ring section 11 is subsequently so placed on the wristwatch 1 as to come into contact with the side facing the display 35 of the wristwatch 1. The male screw 17, which is provided through the receiving surface 10e of the raised section 10b of the base section 10, is then fit into the through hole 11d in the fastening piece 11c. Thereafter, the arm 20 is so caused to pivot that the female screw 21 engages with the male screw 17, and the female screw 21 is rotated with the knob 22 to cause the fastening piece 11c to be sandwiched and fastened between the receiving surface 10e and the female screw 21, so that the ring section 11 is fixed to the base section 10. The sensor attaching tool 2 is thus attached to the wristwatch 1 with the sensor attaching tool 2 holding the wristwatch 1.

To detach the sensor attaching tool 2 from the wristwatch 1, the knob 22 is rotated to loosen the female screw 21, so that the male screw 17 disengages from the female screw 21, and the fastening piece 11c of the ring section 11 is detached from the receiving surface 10e of the base section 10. The sensor attaching tool 2 can then be detached from the wristwatch 1.

In the present embodiment, the wristwatch 1 has daily used functions and includes, as the sensor 9 in the sensor attaching tool 2, at least one of an atmospheric pressure sensor that measures or computes and estimates the altitude, the depth, and the weather, a GPS sensor, a pulse sensor, a motion sensor, an illuminance sensor, an ultraviolet sensor, and other sensors. It is preferable that a user wears only the wristwatch 1 on a daily basis and selects a sensor attaching tool 2 that incorporates an effective sensor in accordance with a scene in which the wristwatch 1 is used, such as mountain climbing, underwater diving, traveling, and sport activities. The user can thus attach, to the wristwatch 1, a sensor attaching tool 2 that incorporates a sensor 9 that the user desires to use in accordance with a scene in which the wristwatch 1 is used.

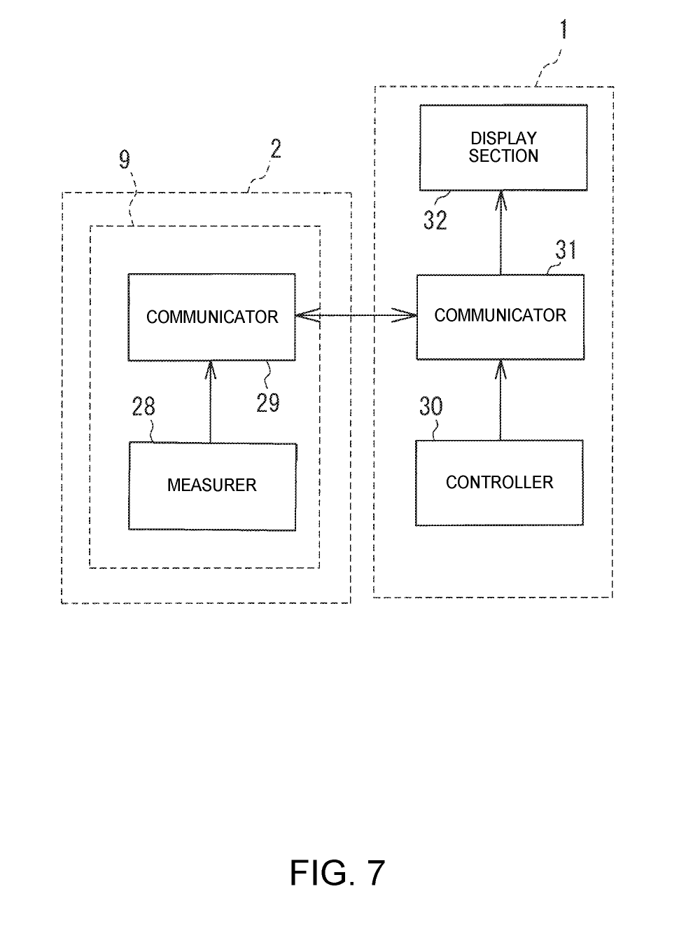

FIG. 7 is a functional block diagram relating to display operation performed by the wristwatch 1 and the sensor attaching tool 2. The wristwatch 1 and the sensor attaching tool 2 each operate based on a built-in battery (not shown) as a power source. The sensor attaching tool 2 and the wristwatch 1 include communicators 29 and 31, respectively, which allow wireless communication compliant, for example, with infrared communication or Bluetooth (registered trademark), and the communication between the communicators 29 and 31 is performed under the control of a controller 30, which is formed of an electronic circuit and provided in the wristwatch 1. A pairing button 10f is an operation knob for establishing the wireless communication between the sensor attaching tool 2 and the wristwatch 1 (pairing). Whether or not a value measured by a measurer 28 in the sensor 9 is displayed may be determined by whether or not a measured value display instruction issued by operation performed on the operation knob 4 provided on the wristwatch 1 has been accepted, or a display 35 of the wristwatch 1 may be caused to display the measured value when the pairing button 10f, which is an operation knob of the sensor attaching tool 2, is operated during the pairing.

A measured signal produced by the sensor 9 and transmitted to the communicator 31 of the wristwatch 1 is converted by a computing portion associated with the controller 30, for example, into the angle of rotation of the second hand 8, and the second hand 8, for example, points at any of the markings 27 provided on the ring section 11 to indicate the measured value. In a case where the wristwatch 1 includes a display 35 that displays information in the digital form, the measured value may be displayed in the form of a numeral.

The communication between the communicators 29 and 31 is not limited to wireless communication and may instead, for example, be wired communication based on electrical contact via connection terminals.

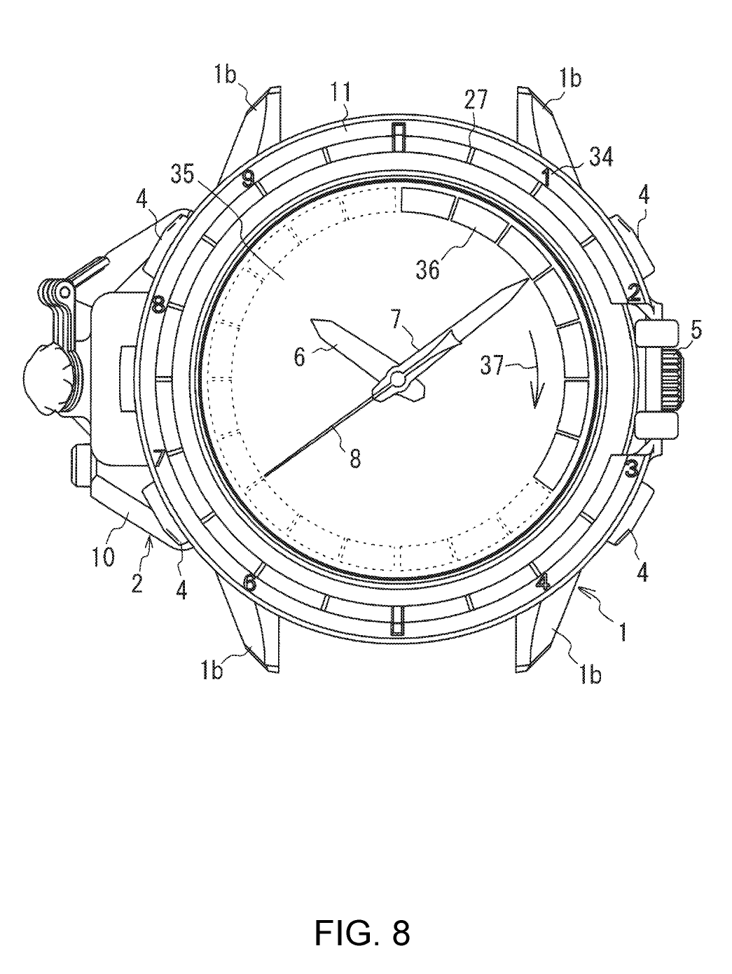

FIG. 8 shows another example of how to display a value measured with the sensor 9. In the example, the sensor 9 is an atmospheric pressure sensor, and markings 27, which divide the circumference of the ring section 11 into ten segments, and numerals 34, which explain the markings 27, are so disposed on the upper surface of the ring section 11 as to indicate the altitude (km). The display 35 of the wristwatch 1 has a graph formed of a plurality of arcuate band-shaped marks 36 drawn with solid lines and representing the altitude, and the higher the altitude, the greater the number of the solid-line marks 36 displayed in the direction indicated by the arrow 37.

As described above, according to the present embodiment, since the sensor attaching tool 2 is so attached to the wristwatch 1 as to hold the wristwatch 1, the function of the wristwatch 1 can be expanded with no sensor attached to the wristwatch 1 itself. Further, since the sensor attaching tool 2 can be attached to and detached from the wristwatch 1 through the attachment/detachment operation using the second holder 14, the sensor attaching tool 2 can be detached from the wristwatch 1 when not required.

The base section 10 and the ring section 11 may instead be joined to each other through a structure that detachably joins the opposite ends of the base section 10 and the ring section 11 to each other with screws. On the other hand, the present embodiment employs the holding structure in which one end of the ring section 11 is pivotably joined to one end of the base section 10 and the other end of the ring section 11 is detachably joined to the other end of the base section 10, and the operation of attaching and detaching the sensor attaching tool 2 to and from the wristwatch 1 is therefore performed only at one location, whereby the attachment/detachment operation is readily performed.

In the present embodiment, the free end of the ring section 11 is not necessarily fixed to the base section 10 with the screw. Instead, the ring section 11 may be provided with a hook, and the hook may be fixed to a hook receiver of the base section 10.

In the present embodiment, since the ring section 11 is provided with the markings 27, which serve as indices that indicate a value measured with the sensor 9, the markings 27, which are not provided on the wristwatch 1, can be added. The markings 27, which serve as measured value indices for the sensor 9, do not therefore need to be added in advance to the wristwatch 1.

In the present embodiment, the ring section 11, which covers the upper surface of the wristwatch 1, provides the function of protecting the upper surface of the wristwatch 1.

Since the sensor attaching tool 2 includes the communicator 29, which allows transmission of a measured value to the wristwatch 1, as shown in FIG. 7, the sensor attaching tool 2 can perform display operation using the display function of the wristwatch 1, whereby the range over which the wristwatch 1 is used can be widened.

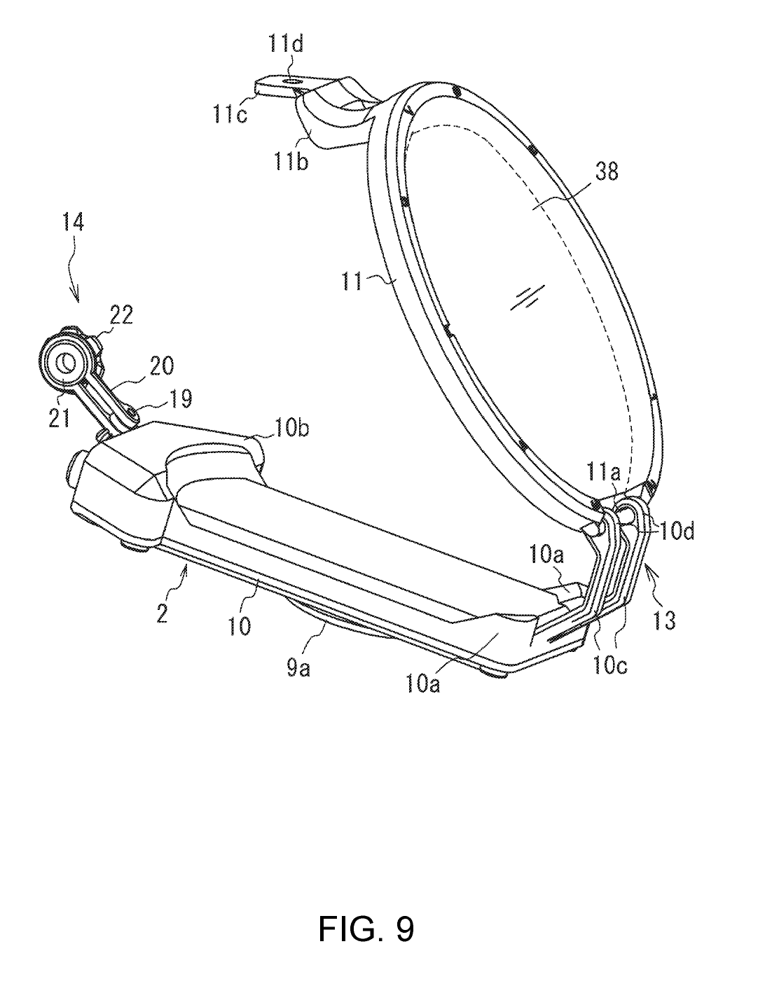

FIG. 9 shows a variation of the sensor attaching tool 2 according to the present embodiment. In the variation, the ring section 11 of the sensor attaching tool 2 is provided with a reinforcing glass plate 38, which serves as a transparent protective member that covers the display 35 of the wristwatch 1. The reinforcing glass plate 38 may be formed of double glass plates for further enhancement of the function of protecting the wristwatch 1. The material of the transparent protective member is not limited to a glass material and may, for example, be a plastic material. The transparent protective member may be replaced with a transmissive display. In this case, the display function can be expanded in addition to the expansion of the sensor function of the information apparatus.

As described above, the transparent reinforcing glass plate 38, which is provided in the ring section 11, can prevent the cover glass plate 3 and the bezel, which are provided on the side facing the display 35 of the wristwatch 1, from coming into direct contact with an object and being damaged. Since the wristwatch 1 can protected, whereby the wristwatch 1 can be more useful as a wristwatch used in a situation in which the wristwatch 1 is likely to come into contact with an object, particularly, in a case where the wristwatch 1 is used in an outdoor activity.

### Second Embodiment

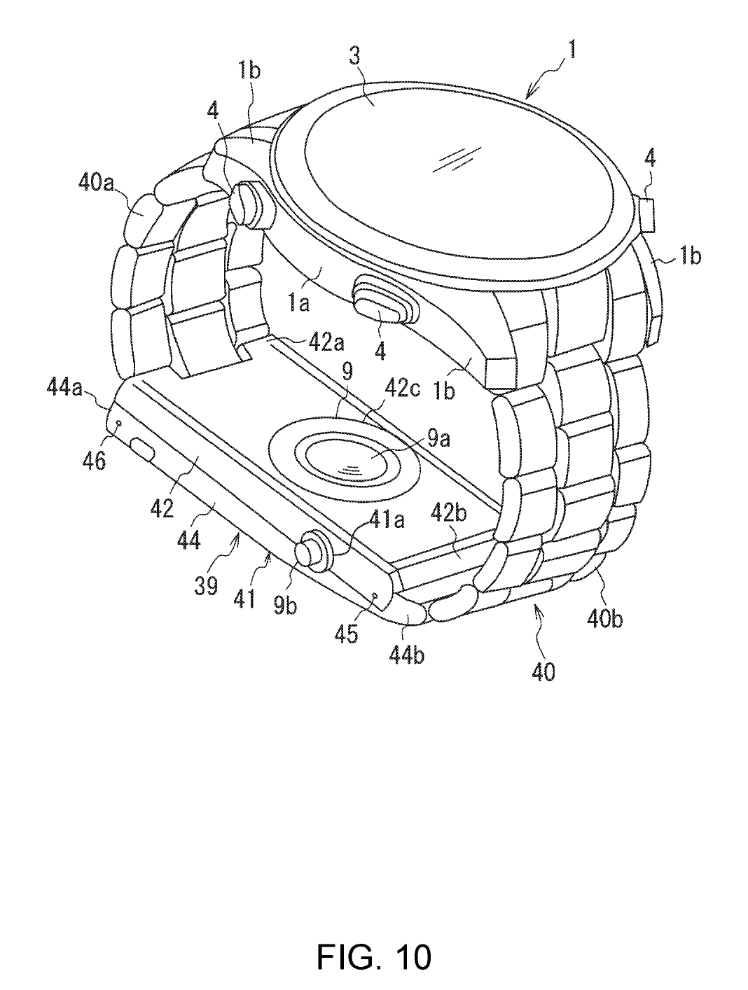

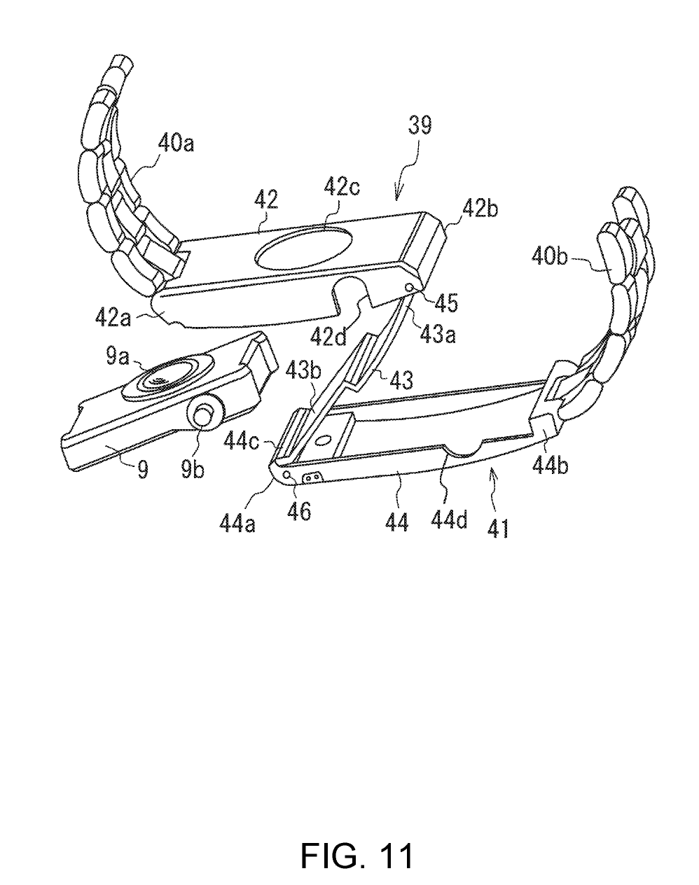

FIG. 10 is a perspective view showing an information apparatus according to a second embodiment of the invention, and FIG. 11 is a perspective view showing a sensor attaching tool 39 for the information apparatus with the sensor 9 detached. In the present embodiment, a band 40, which is attached to the wristwatch 1, which is an information apparatus, and a sensor container 41, which is attached to the band 40, and detachably contains the sensor 9, are provided.

In the present embodiment, since the sensor attaching tool 39 is attached to the band of the wristwatch, the sensor container 41 is so structured as to be provided between two divided bands, a divided band 40a and a divided band 40b.

The sensor container 41 is formed of an upper case 42, which opens downward, a middle case 43, and a lower case 44, which opens upward. The upper case 42 (first case) has a first end 42a, which is pivotably connected to one of the divided bands or the divided band 40a (first band). The middle case 43 (third case) has a first end 43a, which is pivotably connected to a second end 42b of the upper case 42 via a pivotal attachment section 45. The lower case 44 has a first end 44a, which is pivotably connected to a second end 43b of the middle case 43 via a pivotal attachment section 46. A second end 44b of the lower case 44 (second case) is pivotably connected to the other divided band or the divided band 40b (second band). That is, the middle case 43 connects the upper case 42 and the lower case 44 to each other.

To contain the sensor 9 in the sensor container 41 and cause the wristwatch 1 to which the sensor attaching tool 39 is attached to be worn, along with the sensor container 41, around an arm, the user's wrist caused to extend upward is inserted through the space between the sensor attaching tool 39 and the wristwatch 1 with the middle case 43 and the lower case 44 unfolded, as shown in FIG. 11, and the upper case 42 is caused to come into contact with the ventral surface of the wrist. The sensor 9 is then placed in the upper case 42, and the middle case 43 and the lower case 44 are caused to pivot around the pivotal attachment section 45 of the middle case 43 to allow the middle case 43 to close the opening of the upper case 42. A locking section 44c, which is provided at the first end 44a of the lower case 44, is then caused to lock onto a locking receiver (not shown) of the upper case 42 in a snap insertion manner, and the second end 44b of the lower case 44 is caused to engage with the second end 42b of the upper case 42 at the same time. The wristwatch 1 along with the sensor attaching tool 39 can thus be worn around the arm. After the information apparatus is worn on the human body as described above, the upper case 42 (first case), the lower case 44 (second case), and the middle case 43 (third case) overlaid on each other, and the sensor container 41 is detachably contained in the overlaid portion.

Conversely, to detach the sensor attaching tool 39 along which the wristwatch 1 from the arm, the locking section 44c of the lower case 44 is detached from the locking receiver at the first end 42a of the upper case 42, and the middle case 43 and the lower case 44 are caused to pivot around the pivotal attachment section 45 to unfold the middle case 43 and the lower case 44.

In the present embodiment, to allow the sensor 9 to sense biological information, such as the pulse, the sensing section 9a is so provided on one surface of the sensor 9 as to protrude therefrom, and the upper case 42 is provided with an opening 42c, through which the sensing section 9a is exposed out of the upper case 42, so that the sensing section 9a is allowed to come into contact with the wrist in the state in which the sensor 9 is contained in the sensor container 41. The sensor 9 has a pairing button 9b provided on the side portion thereof. A cutout 42d provided in the upper case 42 and a cutout 44d provided in the lower case 44 form an opening 41a in the state in which the sensor container 41 contains the sensor 9. The pairing button 9b, which is exposed through the opening 41a, can be externally operated after the sensor 9 is contained in the sensor container 41.

Also in the embodiment shown in FIGS. 10 and 11, since the sensor attaching tool is attached to the wristwatch 1, the function of the wristwatch 1 can be expanded with no sensor attached to the wristwatch 1 itself. Also in the embodiment shown in FIGS. 10 and 11, the sensor 9 can be a pulse sensor or any of an altitude sensor, a depth sensor, a whether sensor, an atmospheric pressure sensor, a GPS sensor, and any other sensor, as in the embodiment shown in FIGS. 1 to 9.

In the embodiment shown in FIGS. 10 and 11, the sensor 9 may be attached and fixed, for example, to the upper case of the sensor container 41. Instead, employing a configuration that allows the sensor 9 to be so contained as to be readily placed in and removed from the sensor container can provide a sensor attaching tool suitable for an application in which a variety of sensors is switched from one to another and used.

Also in the embodiment shown in FIGS. 10 and 11, providing the sensor attaching tool 39 and the wristwatch 1 with the communicators 29 and 31 shown in FIG. 7 respectively allows display operation using the display function of the wristwatch 1, whereby the range over which the wristwatch 1 is used can be widened.

The invention is applicable, in addition to a wristwatch, to other information apparatus that are worn on an arm. Further, the invention is not limited to the embodiments described above, and a variety of changes and additions can be made to the specific configuration to the extent that the changes and additions fall within the scope of the substance of the invention.

What is claimed is:

1. A sensor attaching tool attached to an information apparatus that includes an exterior case and a display incorporated in the exterior case and is wearable on a human body, the sensor attaching tool comprising:
abase section that incorporates a sensor and is disposed on a human body side of the exterior case when the information apparatus is worn on the human body;
a ring section that is placed on an outer circumferential portion that forms the exterior case and faces the display; and
a holder that allows the base section and the ring section to be held on a side facing a side surface of the exterior case.

2. The sensor attaching tool according to claim 1,
wherein the holder includes
a first holder that pivotably joins the ring section and the base section to each other, and
a second holder that detachably fixes the ring section to the base section with each other.

3. The sensor attaching tool according to claim 1, wherein the ring section has markings indicating a value measured with the sensor.

4. The sensor attaching tool according to claim 1, wherein the ring section includes a transparent member that covers the display of the information apparatus.

5. The sensor attaching tool according to claim 1, wherein the base section or the ring section includes a communicator that transmits a value measured with the sensor to the information apparatus.

6. A sensor attaching tool comprising:
a band attached to an information apparatus to allow the information apparatus to be worn on a human body; and
a sensor container that is attached to the band and contains a sensor,
wherein the band includes a first band, a second band, a first case connected to an end of the first band, a second case connected to an end of the second band, and a third case that connects the first case and the second case to each other, and
when the information apparatus is worn on the human body, the first case, the second case, and the third case are overlaid on each other, and the sensor container is contained in the overlaid portion.

7. The sensor attaching tool according to claim 5, wherein the sensor container includes a communicator that transmits a value measured with the sensor to the information apparatus.

8. An information system comprising:
an information apparatus that includes an exterior case and a display incorporated in the exterior case and is wearable on a human body, and
a sensor attaching tool attached to the information apparatus,
wherein the sensor attaching tool includes
abase section that incorporates a sensor and is disposed on a human body side of the exterior case when the information apparatus is worn on the human body,
a ring section that is placed on an outer circumferential portion that forms the exterior case and faces the display, and
a holder that allows the base section and the ring section to be held on a side facing a side surface of the exterior case.

9. An information system comprising:
an information apparatus;
a band attached to the information apparatus to allow the information apparatus to be worn on a human body; and
a sensor container that is attached to the band and contains a sensor,
wherein the band includes a first band, a second band, a first case connected to an end of the first band, a second case connected to an end of the second band, and a third case that connects the first case and the second case to each other, and
when the information apparatus is worn on the human body, the first case, the second case, and the third case are overlaid on each other, and the sensor container is contained in the overlaid portion.
